(19) United States
(12) Patent Application Publication
(10) Pub. No.: US 2024/0144672 A1
(43) Pub. Date: May 2, 2024

(54) JOINING RASTER DATA AND VECTOR DATA IN AGRICULTURAL DATA PROCESSING

(71) Applicant: Mineral Earth Sciences LLC, Mountain View, CA (US)

(72) Inventors: Nanzhu Wang, Kirkland, WA (US); Zhiqiang Yuan, San Jose, CA (US); Sai Cheemalapati, Bellevue, WA (US)

(21) Appl. No.: 17/978,473

(22) Filed: Nov. 1, 2022

(51) Int. Cl. G06V 20/10; G06T 7/12; G06T 7/136; G06V 10/26; G06V 10/44; G06V 10/70; G06V 20/13

(52) U.S. Cl. CPC G06V 20/188; G06T 7/12; G06T 7/136; G06V 10/26; G06V 10/44; G06V 10/70; G06V 20/13; G06T 2207/10032; G06T 2207/20021; G06T 2207/30188

(57) ABSTRACT

Techniques are disclosed herein that enable generating an updated instance of agricultural image data where portions of the instance of agricultural image data are represented in the updated instance of image data as a vector. Various implementations include identifying a contiguous portion of the instance of agricultural image data that captures the same value. Additional or alternative representations include generating a vector representation of the contiguous portion and generating the updated instance of agricultural image data by replacing portions of the image the corresponding portion with the vector representation.

### BACKGROUND

As agricultural data mining and planning becomes more commonplace, the amount of data analyzed, and the number of sources providing that data, is increasing rapidly. Agricultural data can be used in a variety of ways including crop yield prediction and/or diagnoses. For instance, image data can be processed using one or more machine learning models to generate agricultural predictions. More accurate agricultural predictions can be made by processing higher quality image data. However, as image quality increases, the computational resource requirement also increases. Consequently, computational resources necessary to store and/or process the image data also increases. Consequently, processing agricultural data for agricultural predictions (e.g., for crop yield predictions) often requires significant data storage and data processing resources.

### SUMMARY

Implementations disclosed herein are directed towards processing one or more instances of geolocated agricultural image data to generate one or more corresponding revised instances of the geolocated agricultural image data. In some implementations, a given instance of agricultural data can capture a field, where the field can be represented by a two-dimensional set of cells. Each cell can include a value corresponding to a category of agricultural data captured in a portion of the field corresponding to the cell. For example, the instance of agricultural image data can capture a barley field. The barley field can include a first portion growing barley plants and a second unplanted portion (e.g., the second portion is dirt). Cells corresponding to the barley plants can have a first value and cells corresponding to the unplanted field can have a second value.

In some implementations, the system can process the instance of agricultural image data to identify a contiguous group of cells with the same value. For instance, the system can process the image data to identify a contiguous group of cells with the second value indicating an unplanted portion of the field. In some implementations, the system can generate a vector representation of the contiguous group of cells. A vector representation of the image data represents the image as a combination of one or more geometric shapes (e.g., point(s), line(s), curve(s), polygon(s), one or more additional or alternative shapes, and/or combinations thereof). For example, the system can generate a vector representation of the contiguous group of cells with the second value indicating the unplanted portion of the field, where the vector representation includes a geometric representation of the group of cells along with the category of the group of cells.

In some implementations, the system can generate a revised instance of agricultural image data by replacing the portion corresponding to the contiguous group of cells with the same value with the generated vector representation of those cells. For example, the system can replace the group of cells indicating the unplanted portion of the field with the vector representation of the unplanted portion of the field. In some implementations, the vector representation is a more compact representation of the image data. In other words, by replacing one or more portions of the instance of agricultural image data with vector representations, the revised instance of image data takes fewer computing resources to store and/or process. For example, the revised instance of image data can take less memory to store compared to the instance of image data. Additionally or alternatively, computing resources to process the vector data portion of the revised instance of image data can be reduced. In some implementations, processing the area captured with the vector representation can be performed with a single operation, such as by processing the value indicated by the corresponding group of cells. In contrast, to process the equivalent portion of the image data using the raster representation, the system would need to perform one operation for each cell in the contiguous group of cells.

Accordingly, various implementations described herein are directed towards generating an instance of agricultural image data where portions of the instance of image data are represented using a vector representation. Computational resources (e.g., memory, processor cycles, power, battery, etc.) may be conserved by using the updated instance of agricultural image data. For example, representing large groups of cells (e.g., pixels) as a vector, the updated instance of agricultural image data takes less space to store (e.g., less space to store on a harddrive) compared to the instance of agricultural image data. In some implementations, the vector representation can encompass millions of cells. The data necessary to store millions of cells can be significantly reduced by generating a single vector representation to represent those cells.

Similarly, processing the vector representation of the large group of cells in the updated instance of agricultural image data often only requires a single operation performed on the value corresponding to the vector representation. In contrast, processing the corresponding group of cells in the instance of agricultural image data requires processing the value at each cell individually. As described above, in some implementations the vector representation can encompass millions of cells. Using a vector representation to perform operations on these portions of agricultural image data can significantly conserve computing resources by greatly reducing the number of operations that need to be performed.

The above description is provided only as an overview of some implementations disclosed herein. These and other implementations of the technology are disclosed in additional detail below.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

### BRIEF DESCRIPTION OF THE DRAWINGS

FIG. 1 illustrates an instance of agricultural image data in accordance with various implementations disclosed herein.

FIG. 2 illustrates an example of partitioning an instance of agricultural image data into cells in accordance with various implementations disclosed herein.

FIG. 3 illustrates an example of an instance of agricultural image data partitioned into cells, where each cell corresponds to a category of agricultural data captured in the cell in accordance with various implementations disclosed herein.

FIG. 4 illustrates an example of a contiguous grouping of cells identified in an instance of agricultural image data in accordance with various implementations disclosed herein.

FIG. 5 illustrates an example environment in which various implementations disclosed herein may be implemented.

FIG. 6 is a flowchart illustrating an example process in accordance with various implementations disclosed herein.

FIG. 7 illustrates an example architecture of a computing device.

### DETAILED DESCRIPTION

Turning now to the figures, FIG. 1 illustrates an example instance of agricultural image data. The example instance of image data 100 is image data captured of a farm from overhead. The example instance of image data 100 includes crops 102 (e.g., corn, wheat, tomatoes, barley, cotton, strawberries, spinach, etc.), an unplanted portion of the field 104 (e.g., dirt) and a portion of the instance of image data obscured by cloud(s) 106. In some implementations, the overhead image data can be captured via image sensor(s) affixed to one or more satellites, one or more cube satellite, one or more airplanes, one or more helicopters, one or more unmanned aerial vehicles, one or more additional or alternative objects orbiting earth, one or more additional or alternative aircraft, and/or combinations thereof. In some implementations, the image sensors may include one or more digital cameras, one or more video cameras, one or more thermal imaging sensors, one or more light detection and ranging (“LIDAR”) sensors, one or more additional or alternative imaging sensors, and/or combinations thereof.

In some implementations, the instance of agricultural image data can include a variety of additional information such as (but not limited to), the date the image data was captured, the time the image data was captured, the location of the image data, the location of the image sensor(s) when the image data was captured, the altitude of the image sensor(s) when the image data was captured, etc. In some implementations, the location of the image data and/or the location of the image sensor(s) can be captured via a satellite navigation system (e.g., GPS, GLONASS, GALILEO, BeiDou, etc.), can be captured via one or more additional or alternative location sensors, can be determined based on processing the instance of image data, via one or more additional or alternative methods, and/or combinations thereof.

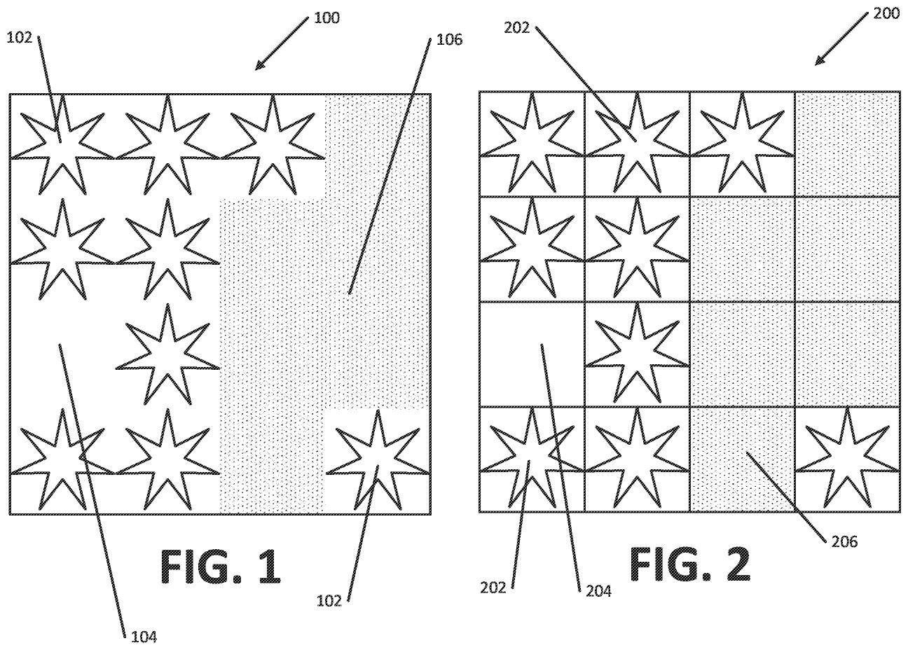

FIG. 2 illustrates an example 200 of the instance of agricultural image data (i.e., the example 100 described in FIG. 1) where the instance of image data has been partitioned into a grid of cells. In the illustrative example 200, the cells are squares, however this is merely illustrative. Cells can include a variety of shapes including (but not limited to) triangles, rectangles, hexagons, etc. In some implementations, individual cells can correspond to individual pixels in the instance of image data, where one cell maps to one pixel, where one cell maps to a group of pixels (e.g., one cell maps to a group of four pixels), etc. Example 200 includes cells 202 corresponding to the crops captured in the instance of image data, a cell 204 corresponding to the unplanted portion of the field captured in the instance of image data, and cells 206 corresponding to the portions of instance of image data blocked by clouds. In the illustrative example, individual crop plants 102 take up an entire cell 202. However, this is merely illustrative. In some implementations, individual crops may take up many cells. In some implementations, the instance of agricultural image data divided into cells 200 can be stored as raster data.

In some implementations, raster data can include a two-dimensional representation of a given field, divided into a plurality of cells. For example, the image data can be represented as a grid of squares. Additionally or alternatively, cells can be of a variety of shapes including (but not limited to) triangles, hexagons, octagons, etc. Each cell can have a corresponding value. For example, the value can indicate a color of one or more pixels corresponding to the cell for rendering the instance of image data. In some implementations, a given cell value can correspond to a category of agriculture captured in the portion of the field corresponding to the given cell.

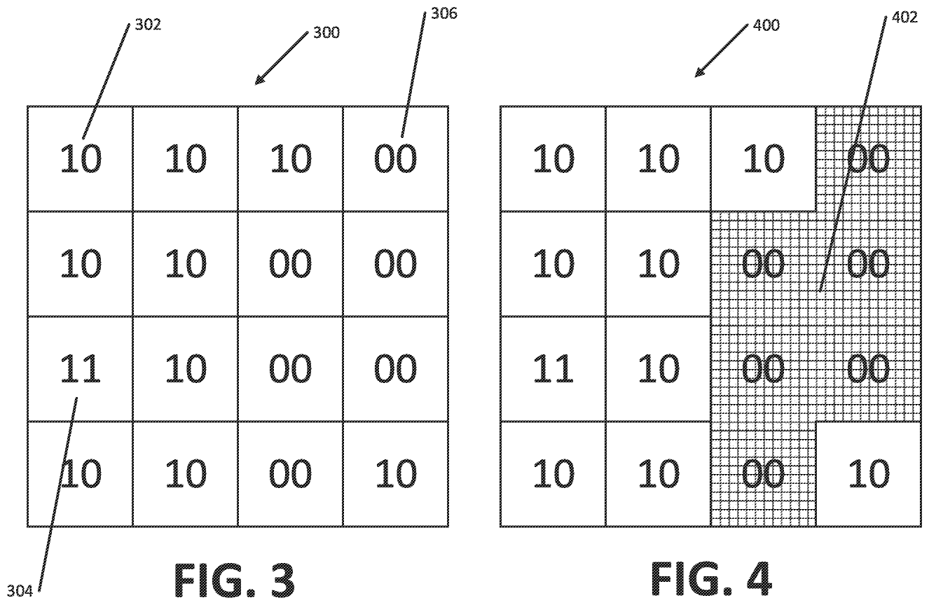

FIG. 3 includes an example 300 of cell values assigned based on the category of agriculture captured in the portion of the image data corresponding to the given cell. In the illustrative example 300, the cell value ‘10’ 302 corresponds to the cells capturing a crop, the cell value ‘11’ 304 corresponds to the cell which captures the unplanted portion of the field, and the cell value ‘00’ correspond to cells which capture the portions of the field blocked by clouds. Although the agricultural categories represented in FIG. 3 are binary numbers, this is merely illustrative. Additional or alternative representations of values can be used including (but not limited to) arabic numbers, letters, words, colors, hexadecimal values, etc.

In some implementations, the system can process the cell values to identify one or more contiguous groups of cells with the same value. For example, example 400 of FIG. 4 illustrates a group of cells 402 that share the value ‘00’ corresponding to clouds. In some implementations, the system can partition portion(s) of the image data into image segments, image regions, image objects, etc. by identifying objects and boundaries (lines, curves, edges, corners, etc.) in the image data. For example, the system can identify curves along the edges of the clouds.

In some implementations, the system can identify a candidate group of cells with the same value, and can determine the number of cells within the candidate group. Additionally or alternatively, the system can determine when the number of cells in the candidate group satisfies one or more conditions, such as a threshold value (e.g., the candidate group includes over 10 cells, over 1,000 cells, over 100,000 cells, over 1,000,000 cells, etc.). In some implementations, the system can identify the contiguous group of cells based on the candidate group of cells satisfying a threshold value. In other words, the system will only identify contiguous groups of cells that are sufficiently large.

In some implementations, a contiguous group of cells, such as the contiguous group of cells 402, can be represented using a vector representation. A vector representation of image data can define geometric shapes (e.g., point(s), line(s), curve(s), polygon(s), one or more additional or alternative shapes, and/or combinations thereof). In some implementations, the vector representation can include a geometric representation of the shape of the contiguous group of cells along with the value corresponding to the contiguous group of cells. For example, the vector representation of the contiguous group of cells 402 can include a geometric representation of the shape of the group of cells 402 along with the value ‘00’ corresponding to the group of cells.

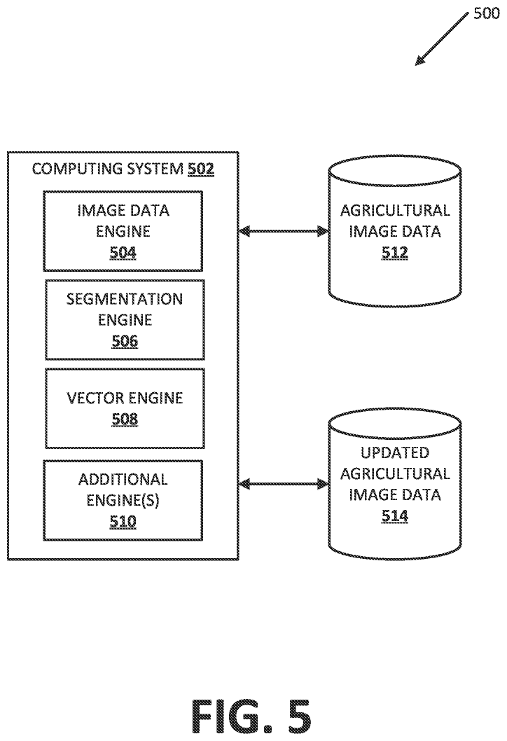

FIG. 5 illustrates a block diagram of an example environment 500 in which implementations disclosed herein may be implemented. The example environment 500 includes a computing system 502 which can include image data engine 504, segmentation engine 506, vector engine 508, and/or one or more additional engines 510. Additionally or alternatively, computing system 502 may be associated with agricultural image data 512, updated agricultural image data 514, and/or one or more additional or alternative components (not depicted).

In some implementations, agricultural image data 512 can include one or more instances of agricultural image data captured from above one or more fields. In some implementations, the instances of image data can be captured via one or more image sensors affixed to one or more satellites, one or more cube satellite, one or more airplanes, one or more helicopters, one or more unmanned aerial vehicles, one or more additional or alternative objects orbiting earth, one or more additional or alternative aircraft, and/or combinations thereof. In some implementations, the image sensors may include one or more digital cameras, one or more video cameras, one or more thermal imaging sensors, one or more light detection and ranging (“LIDAR”) sensors, one or more additional or alternative imaging sensors, and/or combinations thereof. Additionally or alternatively, the instances of agricultural image data can include a variety of additional information such as (but not limited to), the date the image data was captured, the time the image data was captured, the location of the image data, the location of the image sensor(s) when the image data was captured, the altitude of the image sensor(s) when the image data was captured, etc. In some implementations, the location of the image data and/or the location of the image sensor(s) can be captured via a satellite navigation system (e.g., GPS, GLONASS, GALILEO, BeiDou, etc.), can be captured via one or more additional or alternative location sensors, can be determined based on processing the instance of image data, via one or more additional or alternative methods, and/or combinations thereof.

Image data engine 504 can be used to select one or more instances of agricultural image data 512. In some implementations, image data engine 504 can process the instance of agricultural data to divide the instance of image data into one or more cells, each cell with a corresponding value. Additionally or alternatively, one or more instances of agricultural image data 512 may already be divided into cells with corresponding values.

In some implementations, segmentation engine 506 can process the selected instance of agricultural image data to identify one or more contiguous cells in the selected instance of agricultural image data. In some implementations, the segmentation engine 506 can partition portion(s) of the image data into image segments, image regions, image objects, etc. by identifying objects and boundaries (lines, curves, edges, corners, etc.) in the image data. For example, the system can identify curves along the edges of clouds, lines and corners along the edges of a field, etc.

Additionally or alternatively, segmentation engine 506 can identify a candidate group of cells with the same value, and can determine the number of cells within the candidate group. In some implementations, segmentation engine 506 can determine when the number of cells in the candidate group satisfies one or more conditions, such as a threshold value (e.g., the candidate group includes over 10 cells, over 1,000 cells, over 100,000 cells, over 1,000,000 cells, etc.). For example, the contiguous group of cells based on the candidate group of cells satisfying a threshold value. In other words, the system will only identify contiguous groups of cells that are sufficiently large.

In some implementations, vector engine 508 can be used to generate a vector representation of one or more contiguous groups of cells with the same value. For example, vector engine 508 can generate a vector representation of a contiguous group of cells identified using segmentation engine 506. A vector representation of image data can define geometric shapes (e.g., point(s), line(s), curve(s), polygon(s), one or more additional or alternative shapes, and/or combinations thereof). In some implementations, the vector representation can include a geometric representation of the shape of the contiguous group of cells along with the value corresponding to the contiguous group of cells.

In some implementations, image data engine 504 can generate an updated instance of agricultural image data 514 by replacing the portion(s) of the selected instance of agricultural image data (e.g., selected using image data engine 504 as described above) corresponding to the identified contiguous group of cells (e.g., identified using segmentation engine 506) with the vector representation of those cells (e.g., the vector representation generated using vector engine 508). In some implementations, image data engine 504 can store the updated instance of agricultural image data.

The computing system 502 can include one or more additional engines 510. For example, an additional engine can identify a first contiguous grouping of cells and a second contiguous grouping of cells with the same corresponding value. In some implementations, the additional engine 510 can join the first and second continuous grouping of cells. For instance, the additional engine 510 can use one or more vector-vector joining methods such as R-TREE.

Additionally or alternatively, one or more additional engines 510 can process one or more updated instances of agricultural image data 514. For example, one or more of the additional engines 510 can determine a predicted percentage of a field planted with a specific crop, a predicted harvest date for a farm, a predicted amount of fertilizer to use on a plot of land, and/or one or more additional or alternative predictions.

The instance of agricultural image data 512 can be processed using image data engine 504 to divide the instance image data into cells. As an illustrative example, an instance of agricultural image data 512 can capture a field planted with corn, where the field also contains weeds. In some implementations, the instance of agricultural image data capturing corn and weeds can be divided into a grid of 1,000,000 by 1,000,000 square cells. Additionally or alternatively, imagedata engine 504 can identify a value corresponding to the portion of the field captured in the cell. For example, the system can identify cell(s) corresponding to portion(s) of the image data capturing corn with the value ‘1’, cell(s) corresponding to portion(s) of the image data capturing a weed with the value ‘2’, cell(s) corresponding to portion(s) of the image data capturing unplanted soil with the value ‘3’, etc.

Furthermore, segmentation engine 506 can be used to identify one or more contiguous groups of cells in the instance of agricultural image data. For example, segmentation engine 506 can identify a contiguous group of 10,000 cells capturing corn (e.g., cells with the corresponding value ‘1’), a first contiguous group of 1,000 cells capturing weeds (e.g., cells with the corresponding value ‘2’), a second contiguous group of 10,000 cells capturing weeds, and a third contiguous group of 100,000 cells capturing weeds. In some implementations, vector engine 508 can generate a corn vector representation corresponding to the group of 10,000 corn cells, a first weed vector representation corresponding to the first group of 1,000 weed cells, a second weed vector representation corresponding to the second group of 10,000 weed cells, and a third weed vector representation corresponding to the third group of 100,000 weed cells. In some of those implementations, vector engine 508 can join the first weed vector representation, the second weed vector representation, and the third weed vector representation into a joint weed vector representation.

Additionally or alternatively, image data engine 504 can generate an updated instance of agricultural image data 514 based on the instance of agricultural image data and the vector representation(s) of the contiguous group(s) of cells. For instance, image data engine 504 can generate an updated instance of agricultural image data capturing the corn and weeds based on the initial instance of agricultural image data and the corn vector representation and the joint weed vector representation described herein.

Additionally or alternatively, one or more of the additional engines 510 can process the updated instance of agricultural image data 514 to determine a predicted amount of weed killer necessary to kill the weeds in the corn field. By processing the updated instance of agricultural image data 514, the additional engine 510 can perform a single operation on corn vector representation corresponding to the group of 10,000 corn cells instead of performing the operation on each of the 10,000 corn cells individually (i.e., performing 10,000 operations). Similarly, the additional engine 510 can perform a single operation on each of the cells in the joint weed vector representation representing the 111,000 weed cells instead of performing the operation on each of the 111,000 weed cells individually (i.e., performing 111,000 operations). Computational efficiencies (e.g., time, memory, processor cycles, power, etc.) can be achieved by processing one or more updated instances of agriculture image data in place of one or more corresponding initial instances of agricultural image data.

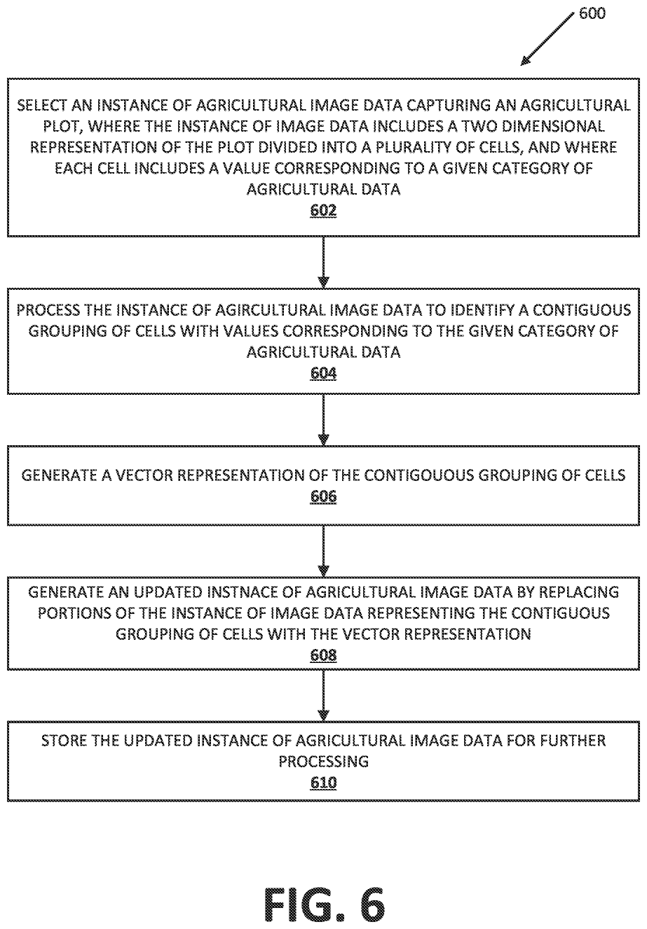

FIG. 6 is a flowchart illustrating an example process 600 of processing an instance of agricultural image data in accordance with implementations disclosed herein. For convenience, the operations of the flowchart are described with reference to a system that performs the operations. This system may include various components of various computer systems, such as one or more components of computing system 502, and/or computing system 710. Moreover, while operations of process 600 are shown in a particular order, this is not meant to be limiting. One or more operations may be reordered, omitted, and/or added.

At block 602, the system selects an instance of agricultural image data capturing an agricultural plot. In some implementations, the instance of image data includes a two dimensional representation of the plot divided into a plurality of cells. In some implementations, each cell includes a value which corresponds to a category of agricultural data. For example, the system can select an instance of agricultural image data 512 using image data engine 504 described with respect to FIG. 5.

At block 604, the system processes the instance of agricultural image data to identify a contiguous grouping of cells with the same value. For example, the system can identify a contiguous grouping of cells with the same value using segmentation engine 506 described with respect to FIG. 5.

At block 606, the system generates a vector representation of the contiguous grouping of cells. For example, the system can generate a vector representation of the contiguous grouping of cells using vector engine 508 described with respect to FIG. 5.

At block 608, the system generates an updated instance of agricultural image data by replacing portions of the instance of image data representing the contiguous grouping of cells with the vector representation. For example, the system can generate the updated instance of agricultural image data using image data engine 504 described with respect to FIG. 5.

At block 610, the system stores the updated instance of agricultural image data for further processing. In some implementations, the system can perform one or more mathematical operations on the updated instance of image data. Computational resources can be conserved by processing the updated instance of agricultural image data instead of the instance of agricultural image data. When processing the vector representation portion of the updated instance of image data, the mathematical operation only needs to be performed once, on the value corresponding to the vector representation of the contiguous group of cells. In contrast, performing the mathematical operation on the same portion of the instance of agricultural image data can require performing the operation once for every cell.

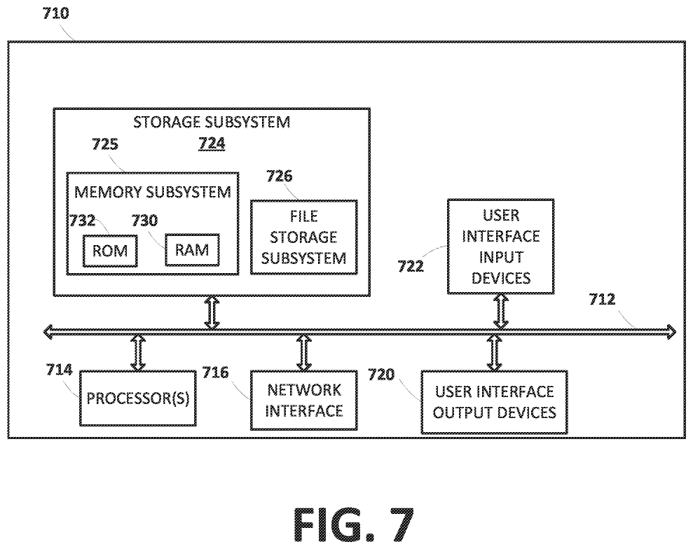

FIG. 7 is a block diagram of an example computing device 710 that may optionally be utilized to perform one or more aspects of techniques described herein. In some implementations, one or more of a client computing device, and/or other component(s) may comprise one or more components of the example computing device 710.

Computing device 710 typically includes at least one processor 714 which communicates with a number of peripheral devices via bus subsystem 712. These peripheral devices may include a storage subsystem 724, including, for example, a memory subsystem 725 and a file storage subsystem 726, user interface output devices 720, user interface input devices 722, and a network interface subsystem 716. The input and output devices allow user interaction with computing device 710. Network interface subsystem 716 provides an interface to outside networks and is coupled to corresponding interface devices in other computing devices.

User interface input devices 722 may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into computing device 710 or onto a communication network.

User interface output devices 720 may include a display subsystem, a printer, a fax machine, or non-visual displays such as audio output devices. The display subsystem may include a cathode ray tube (“CRT”), a flat-panel device such as a liquid crystal display (“LCD”), a projection device, or some other mechanism for creating a visible image. The display subsystem may also provide non-visual display such as via audio output devices. In general, use of the term “output device” is intended to include all possible types of devices and ways to output information from computing device 710 to the user or to another machine or computing device.

Storage subsystem 724 stores programming and data constructs that provide the functionality of some or all of the modules described herein. For example, the storage subsystem 724 may include the logic to perform selected aspects of the process of FIG. 6, as well as to implement various components depicted in FIG. 5.

These software modules are generally executed by processor 714 alone or in combination with other processors. Memory 725 used in the storage subsystem 724 can include a number of memories including a main random access memory (“RAM”) 730 for storage of instructions and data during program execution and a read only memory (“ROM”) 732 in which fixed instructions are stored. A file storage subsystem 726 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 726 in the storage subsystem 724, or in other machines accessible by the processor(s) 714.

Bus subsystem 712 provides a mechanism for letting the various components and subsystems of computing device 710 communicate with each other as intended. Although bus subsystem 712 is shown schematically as a single bus, alternative implementations of the bus subsystem may use multiple buses.

Computing device 710 can be of varying types including a workstation, server, computing cluster, blade server, server farm, or any other data processing system or computing device. Due to the ever-changing nature of computers and networks, the description of computing device 710 depicted in FIG. 7 is intended only as a specific example for purposes of illustrating some implementations. Many other configurations of computing device 710 are possible having more or fewer components than the computing device depicted in FIG. 7.

In situations in which the systems described herein collect personal information about users (or as often referred to herein, “participants”), or may make use of personal information, the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

In some implementations, a method implemented by one or more processors is provided, the method includes selecting an instance of geolocated agricultural image data capturing an agricultural plot. In some implementations, the instance of geolocated agricultural image data includes a two dimensional representation of the agricultural plot which is divided into a plurality of cells. In some implementations, each cell represents a respective category of agricultural data from a plurality of categories of agricultural data captured in the corresponding portion of the agricultural plot. In some implementations, the method includes processing the instance of geolocated agricultural image data to identify a contiguous grouping of cells which represent a given category of agricultural data. In some implementations, the method includes generating a vector representation of the contiguous grouping of cells which includes a representation of the boundaries of the contiguous grouping of cells and the given category of agricultural data. In some implementations, the method includes generating an updated instance of geolocated agricultural image data by replacing the portion of the instance of geolocated agricultural image data representing the contiguous grouping of cells with the vector representation. In some implementations, the method includes storing the updated instance of geolocated agricultural image data for further agricultural processing.

These and other implementations of the technology disclosed herein can include one or more of the following features.

In some implementations, the instance of geolocated agricultural image data is captured via one or more image sensors mounted on a satellite.

In some implementations, processing the instance of geolocated agricultural to identify the contiguous grouping of cells which represent the given category of agricultural data includes determining the number of cells in a candidate grouping of cells. In some implementations, the method further includes determining whether the number of cells in the candidate grouping of cells satisfies a threshold value. In some implementations, in response to determining the number of cells in the candidate grouping of cells satisfies the threshold value, the method further includes identifying the candidate grouping of cells as the contiguous grouping of cells.

In some implementations, the method further includes processing a plurality of updated instances of agricultural image data, where each of the instances in the plurality of updated instances of agricultural image data captures the same geographical location, using an agricultural machine learning model to generate a predicted crop yield.

In some implementations, processing the instance of geolocated agricultural image data to identify the contiguous grouping of cells which represent the given category of agricultural data includes identifying one or more edges in the instance of geolocated agricultural image data. In some implementations, the method further includes processing a plurality of cells in the instance of agricultural image to generate a candidate grouping of cells based on the identified one or more edges. In some implementations, the method further includes processing the candidate grouping of cells to determine whether the candidate grouping of cells represent the given category of agricultural data. In some implementations, in response to determining the candidate grouping of cells represents the given category of agricultural data, the method further includes identifying the contiguous grouping of cells based on the candidate grouping of cells.

In some implementations, processing the instance of geolocated agricultural image data to identify the contiguous grouping of cells which represent the given category of agricultural data includes identifying one or more objects in the instance of geolocated agricultural image data. In some implementations, the method further includes processing a plurality of cells in the instance of agricultural image to generate a candidate grouping of cells based on the identified one or more objects. In some implementations, the method further includes processing the candidate grouping of cells to determine whether the candidate grouping of cells represent the given category of agricultural data. In some implementations, in response to determining the candidate grouping of cells represents the given category of agricultural data, the method further includes identifying the contiguous grouping of cells based on the candidate grouping of cells.

In some implementations, the plurality of agricultural categories includes a class of crops captured in the instance of geolocated agricultural image data, a cloud captured in the instance of geolocated agricultural image data, and an unplanted portion of the plot captured in the instance of geolocated agricultural image data.

In addition, some implementations include one or more processors (e.g., central processing unit(s) (CPU(s)), graphics processing unit(s) (GPU(s), and/or tensor processing unit(s) (TPU(s)) of one or more computing devices, where the one or more processors are operable to execute instructions stored in associated memory, and where the instructions are configured to cause performance of any of the methods described herein. Some implementations also include one or more transitory or non-transitory computer readable storage media storing computer instructions executable by one or more processors to perform any of the methods described herein.

What is claimed is:

1. A method implemented by one or more processors, the method comprising:
selecting an instance of geolocated agricultural image data capturing an agricultural plot,
where the instance of geolocated agricultural image data includes a two dimensional representation of the agricultural plot which is divided into a plurality of cells, and
wherein each cell represents a respective category of agricultural data from a plurality of categories of agricultural data captured in the corresponding portion of the agricultural plot;
processing the instance of geolocated agricultural image data to identify a contiguous grouping of cells which represent a given category of agricultural data;
generating a vector representation of the contiguous grouping of cells which includes a representation of the boundaries of the contiguous grouping of cells and the given category of agricultural data;
generating an updated instance of geolocated agricultural image data by replacing the portion of the instance of geolocated agricultural image data representing the contiguous grouping of cells with the vector representation; and
storing the updated instance of geolocated agricultural image data for further agricultural processing.

2. The method of claim 1, wherein the instance of geolocated agricultural image data is captured via one or more image sensors mounted on a satellite.

3. The method of claim 1, wherein processing the instance of geolocated agricultural to identify the contiguous grouping of cells which represent the given category of agricultural data comprises:
determining the number of cells in a candidate grouping of cells;
determining whether the number of cells in the candidate grouping of cells satisfies a threshold value; and
in response to determining the number of cells in the candidate grouping of cells satisfies the threshold value, identifying the candidate grouping of cells as the contiguous grouping of cells.

4. The method of claim 1, further comprising:
processing a plurality of updated instances of agricultural image data, where each of the instances in the plurality of updated instances of agricultural image data captures the same geographical location, using an agricultural machine learning model to generate a predicted crop yield.

5. The method of claim 1, wherein processing the instance of geolocated agricultural image data to identify the contiguous grouping of cells which represent the given category of agricultural data comprises:
identifying one or more edges in the instance of geolocated agricultural image data;
processing a plurality of cells in the instance of agricultural image to generate a candidate grouping of cells based on the identified one or more edges;
processing the candidate grouping of cells to determine whether the candidate grouping of cells represent the given category of agricultural data; and
in response to determining the candidate grouping of cells represents the given category of agricultural data, identifying the contiguous grouping of cells based on the candidate grouping of cells.

6. The method of claim 1, wherein processing the instance of geolocated agricultural image data to identify the contiguous grouping of cells which represent the given category of agricultural data comprises:
identifying one or more objects in the instance of geolocated agricultural image data;
processing a plurality of cells in the instance of agricultural image to generate a candidate grouping of cells based on the identified one or more objects;
processing the candidate grouping of cells to determine whether the candidate grouping of cells represent the given category of agricultural data; and
in response to determining the candidate grouping of cells represents the given category of agricultural data, identifying the contiguous grouping of cells based on the candidate grouping of cells.

7. The method of claim 1, wherein the plurality of agricultural categories includes a class of crops captured in the instance of geolocated agricultural image data, a cloud captured in the instance of geolocated agricultural image data, and an unplanted portion of the plot captured in the instance of geolocated agricultural image data.

8. A non-transitory computer readable medium configured to store instructions that, when executed by one or more processors, cause the one or more processors to perform operations that include:
selecting an instance of geolocated agricultural image data capturing an agricultural plot,
where the instance of geolocated agricultural image data includes a two dimensional representation of the agricultural plot which is divided into a plurality of cells, and
wherein each cell represents a respective category of agricultural data from a plurality of categories of agricultural data captured in the corresponding portion of the agricultural plot;
processing the instance of geolocated agricultural image data to identify a contiguous grouping of cells which represent a given category of agricultural data;
generating a vector representation of the contiguous grouping of cells which includes a representation of the boundaries of the contiguous grouping of cells and the given category of agricultural data;
generating an updated instance of geolocated agricultural image data by replacing the portion of the instance of geolocated agricultural image data representing the contiguous grouping of cells with the vector representation; and
storing the updated instance of geolocated agricultural image data for further agricultural processing.

9. The non-transitory computer readable medium of claim 8, wherein the instance of geolocated agricultural image data is captured via one or more image sensors mounted on a satellite.

10. The non-transitory computer readable medium of claim 8, wherein processing the instance of geolocated agricultural to identify the contiguous grouping of cells which represent the given category of agricultural data comprises:
determining the number of cells in a candidate grouping of cells;
determining whether the number of cells in the candidate grouping of cells satisfies a threshold value; and
in response to determining the number of cells in the candidate grouping of cells satisfies the threshold value, identifying the candidate grouping of cells as the contiguous grouping of cells.

11. The non-transitory computer readable medium of claim 8, wherein causing the one or more processors to perform operations further includes:
processing a plurality of updated instances of agricultural image data, where each of the instances in the plurality of updated instances of agricultural image data captures the same geographical location, using an agricultural machine learning model to generate a predicted crop yield.

12. The non-transitory computer readable medium of claim 8, wherein processing the instance of geolocated agricultural image data to identify the contiguous grouping of cells which represent the given category of agricultural data comprises:
identifying one or more edges in the instance of geolocated agricultural image data;
processing a plurality of cells in the instance of agricultural image to generate a candidate grouping of cells based on the identified one or more edges;
processing the candidate grouping of cells to determine whether the candidate grouping of cells represent the given category of agricultural data; and
in response to determining the candidate grouping of cells represents the given category of agricultural data, identifying the contiguous grouping of cells based on the candidate grouping of cells.

13. The non-transitory computer readable medium of claim 8, wherein processing the instance of geolocated agricultural image data to identify the contiguous grouping of cells which represent the given category of agricultural data comprises:
identifying one or more objects in the instance of geolocated agricultural image data;
processing a plurality of cells in the instance of agricultural image to generate a candidate grouping of cells based on the identified one or more objects;
processing the candidate grouping of cells to determine whether the candidate grouping of cells represent the given category of agricultural data; and
in response to determining the candidate grouping of cells represents the given category of agricultural data, identifying the contiguous grouping of cells based on the candidate grouping of cells.

14. The non-transitory computer readable medium of claim 8, wherein the plurality of agricultural categories includes a class of crops captured in the instance of geolocated agricultural image data, a cloud captured in the instance of geolocated agricultural image data, and an unplanted portion of the plot captured in the instance of geolocated agricultural image data.

15. A system comprising:
one or more processors; and
memory configured to store instructions, that when executed by the one or more processors cause the one or more processors to perform operations that include:
selecting an instance of geolocated agricultural image data capturing an agricultural plot,
where the instance of geolocated agricultural image data includes a two dimensional representation of the agricultural plot which is divided into a plurality of cells, and
wherein each cell represents a respective category of agricultural data from a plurality of categories of agricultural data captured in the corresponding portion of the agricultural plot;
processing the instance of geolocated agricultural image data to identify a contiguous grouping of cells which represent a given category of agricultural data;
generating a vector representation of the contiguous grouping of cells which includes a representation of the boundaries of the contiguous grouping of cells and the given category of agricultural data;
generating an updated instance of geolocated agricultural image data by replacing the portion of the instance of geolocated agricultural image data representing the contiguous grouping of cells with the vector representation; and
storing the updated instance of geolocated agricultural image data for further agricultural processing.

16. The system of claim 15, wherein the instance of geolocated agricultural image data is captured via one or more image sensors mounted on a satellite.

17. The system of claim 15, wherein processing the instance of geolocated agricultural to identify the contiguous grouping of cells which represent the given category of agricultural data comprises:
determining the number of cells in a candidate grouping of cells;
determining whether the number of cells in the candidate grouping of cells satisfies a threshold value; and
in response to determining the number of cells in the candidate grouping of cells satisfies the threshold value, identifying the candidate grouping of cells as the contiguous grouping of cells.

18. The system of claim 15, wherein the memory configured to store instructions, that when executed by the one or more processors cause the one or more processors to perform operations that further include:
processing a plurality of updated instances of agricultural image data, where each of the instances in the plurality of updated instances of agricultural image data captures the same geographical location, using an agricultural machine learning model to generate a predicted crop yield.

19. The system of claim 15, wherein processing the instance of geolocated agricultural image data to identify the contiguous grouping of cells which represent the given category of agricultural data comprises:
identifying one or more edges in the instance of geolocated agricultural image data;
processing a plurality of cells in the instance of agricultural image to generate a candidate grouping of cells based on the identified one or more edges;
processing the candidate grouping of cells to determine whether the candidate grouping of cells represent the given category of agricultural data; and
in response to determining the candidate grouping of cells represents the given category of agricultural data, identifying the contiguous grouping of cells based on the candidate grouping of cells.

20. The system of claim 15, wherein processing the instance of geolocated agricultural image data to identify the contiguous grouping of cells which represent the given category of agricultural data comprises:
identifying one or more objects in the instance of geolocated agricultural image data;
processing a plurality of cells in the instance of agricultural image to generate a candidate grouping of cells based on the identified one or more objects;
processing the candidate grouping of cells to determine whether the candidate grouping of cells represent the given category of agricultural data; and
in response to determining the candidate grouping of cells represents the given category of agricultural data, identifying the contiguous grouping of cells based on the candidate grouping of cells.
